(19) United States
(12) Patent Application Publication
(10) Pub. No.: US 2026/0333161 A1
(43) Pub. Date: Oct. 22, 2026

(54) NODE, USER EQUIPMENT IN WIRELESS COMMUNICATION SYSTEM AND METHOD PERFORMED BY THE SAME

(71) Applicant: Samsung Electronics Co., Ltd., Gyeonggi-do (KR)

(72) Inventors: Yu PAN, Beijing (CN); Weiwei WANG, Beijing (CN); Hong WANG, Beijing (CN); Lixiang XU, Beijing (CN)

(21) Appl. No.: 19/105,563

(22) PCT Filed: Sep. 15, 2023
(86) PCT No.: PCT/KR2023/013901

§ 371 Date: Feb. 21, 2025

(30) Foreign Application Priority Data
Sep. 26, 2022 (CN) 202211177545.0
Nov. 2, 2022 (CN) 202211364787.0

(51) Int. Cl. H04W 36/04; H04W 36/00; H04W 56/00; H04W 72/231

(52) U.S. Cl. CPC H04W 36/04; H04W 36/0058; H04W 36/0061; H04W 36/0072; H04W 56/0045; H04W 72/231

(57) ABSTRACT

The disclosure relates to a 5G or 6G communication system for supporting a higher data transmission rate. The disclosure provides a node, user equipment in a wireless communication system and a method performed by the same. The method performed by a first node includes: receiving related information of a first candidate cell; transmitting a first message to a user equipment, wherein the first message includes synchronization indication information and related information of a second candidate cell, and the second candidate cell is based on group information to which the first candidate cell belongs; and transmitting a handover related indication to the user equipment.

### TECHNICAL FIELD

The present disclosure relates to a technical field of wireless communication, and more specifically, it relates to a node, user equipment in a wireless communication system and a method performed by the same.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre- 5G communication system. Therefore, the 5G or pre-5G communication system is also called “beyond 4G network” or “post LTE system”.

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Solution to Problem

Embodiments of the disclosure provide a method performed by a first node in a wireless communication system, which includes: receiving related information of a first candidate cell; transmitting a first message to a user equipment, wherein the first message includes synchronization indication information and related information of a second candidate cell, and the second candidate cell is based on group information to which the first candidate cell belongs; and transmitting a handover related indication to the user equipment.

According to embodiments of the disclosure, the method further includes: receiving group information to which the first candidate cell belongs from a second node; or performing grouping based on the related information of the first candidate cell, and determining the group information.

According to embodiments of the disclosure, transmitting a handover related indication to the user equipment includes one of the following: transmitting a handover command to the user equipment, wherein the handover command includes information of a target cell; or transmitting a reconfiguration message to the user equipment, wherein the reconfiguration message includes information of a third candidate cell and/or handover execution conditions. In some implementations, the third candidate cell may be the first candidate cell described above or other candidate cells different from the first candidate cell.

According to embodiments of the disclosure, the method further includes:

transmitting a message for handover execution indication to the second node, wherein the message for handover execution indication includes at least one of: related information of a changed cell; and identifier of a target cell.

According to embodiments of the disclosure, the method further includes: transmitting a synchronization signal and related information of the second candidate cell to a second node.

According to embodiments of the disclosure, the method further includes: receiving a timing advance value related to the second candidate cell from a second node.

According to embodiments of the disclosure, the method further includes: transmitting first cell configuration information received from a second node to the user equipment; and transmitting an indication of whether to adopt the first cell configuration information and/or cell related information for reference received from the second node to the user equipment.

According to embodiments of the disclosure, transmitting a handover related indication to the user equipment further includes transmitting the timing advance value to the user equipment.

According to embodiments of the disclosure, the method further includes: receiving a reconfiguration message for the user equipment from a second node; and transmitting a response message to the second node, wherein the response message includes at least one of a rejection cause, a target cell of L1/L2 handover and configuration information of the target cell of L1/L2 handover.

Embodiments of the disclosure provides a method performed by user equipment in a wireless communication system, which includes: receiving a first message from a first node, wherein the first message includes synchronization indication information and related information of a second candidate cell, and the second candidate cell is based on group information to which a first candidate cell belongs; and receiving a handover related indication from the first node, wherein related information of the first candidate cell is received by the first node.

According to embodiments of the disclosure, receiving a handover related indication from the first node includes one of the following: receiving a handover command from the first node, wherein the handover command includes information of a target cell, and monitoring a PDCCH based on the information of the target cell; or receiving a reconfiguration message from the first node, wherein the reconfiguration message includes information of a third candidate cell and/or handover execution conditions; selecting a target cell based on the information of the third candidate cell and/or handover execution conditions, and monitoring a PDCCH.

According to embodiments of the disclosure, receiving a handover related indication from the first node further includes receiving a timing advance value from the first node.

According to embodiments of the disclosure, the method further includes:

transmitting a preamble to the second candidate cell; receiving a random access response message from the second candidate cell, wherein the random access response message includes the preamble and a timing advance value corresponding to the uplink preamble.

According to embodiments of the disclosure, the method further includes: receiving first cell configuration information from the first node; and receiving an indication of whether to adopt the first cell configuration information and/or cell related information for reference from the first node.

Embodiments of the disclosure provides a method performed by a second node in a wireless communication system, which includes: transmitting related information of a first candidate cell to a first node; and receiving a response message transmitted by a first node; wherein the related information of the first candidate cell and group information to which the first candidate cell belongs are used to determine a second candidate cell, and wherein related information of the second candidate cell and synchronization indication information are used to be transmitted to a user equipment for synchronization between the user equipment and the second candidate cell.

According to embodiments of the disclosure, the method further includes: transmitting group information to which the first candidate cell belongs to the first node.

According to embodiments of the disclosure, the method further includes: transmitting first cell configuration information to the first node; and transmitting an indication of whether to adopt the first cell configuration information and/or cell related information for reference to the first node.

According to embodiments of the disclosure, the method further includes: receiving a message for handover execution indication from the first node, wherein the handover execution indication message includes at least one of: related information of a changed cell; and identifier of a target cell.

According to embodiments of the disclosure, the method further includes: receiving a synchronization signal and related information of the second candidate cell from the first node.

According to embodiments of the disclosure, the method further includes: transmitting a timing advance value related to a second candidate cell to the first node.

Embodiments of the disclosure provide a node in a wireless communication system, including: a transceiver configured to transmit and receive signals; and a controller coupled with the transceiver and configured to perform the methods performed by a node in a wireless communication system according to embodiments of the disclosure.

Embodiments of the disclosure provides a user equipment in a wireless communication system, including: a transceiver configured to transmit and receive signals; and a controller coupled with the transceiver and configured to perform the methods performed by a user equipment in the wireless communication system according to embodiments of the disclosure.

Embodiments of the disclosure provide a computer-readable medium having stored thereon computer-readable instructions which, when executed by a processor, can be used to implement any method according to embodiments of the disclosure.

The methods performed by the first node, the second node and/or the user equipment in the wireless communication system provided by the embodiments of the disclosure can reduce handover delay of the UE and ensure service transmission quality of the UE.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The above and other aspects, features and advantages of certain embodiments of the disclosure will be more apparent from the following description taken in conjunction with the accompanying drawings, in which:

FIG. 1 is an exemplary system architecture 100 of system architecture evolution (SAE);

FIG. 2 is an exemplary system architecture 200 according to various embodiments of the disclosure;

FIG. 3 illustrates an example signal flow of a method for reducing handover delay according to embodiments of the disclosure;

FIG. 4 illustrates an example signal flow of another method for reducing handover delay according to embodiments of the disclosure;

FIG. 5 illustrates an example signal flow of a cooperation method of L1/L2 handover and L3 handover according to embodiments of the disclosure;

FIG. 6 illustrates an example signal flow of another cooperation method of L1/L2 handover and L3 handover according to embodiments of the disclosure;

FIG. 7 illustrates another cooperation method of L1/L2 handover and L3 handover according to embodiments of the disclosure;

FIG. 8 illustrates an example signal flow of a method for recovering a service connection when the UE determines that L1/L2 handover fails, according to embodiments of the disclosure;

FIG. 9 illustrates an example signal flow of an L1/L2 target cell selection method according to embodiments of the disclosure;

FIG. 10 illustrates a flowchart of a method performed by a first node in a wireless communication system according to embodiments of the disclosure;

FIG. 11 illustrates a flowchart of a method performed by a user equipment in a wireless communication system according to embodiments of the disclosure;

FIG. 12 illustrates a flowchart of a method performed by a second node in a wireless communication system according to embodiments of the disclosure;

FIG. 13 illustrates a schematic diagram of a node in a wireless communication system according to embodiments of the disclosure;

FIG. 14 illustrates a schematic diagram of a user equipment according to embodiments of the disclosure;

FIG. 15 illustrates another cooperation method of L1/L2 handover and L3 handover according to embodiments of the disclosure;

FIG. 16 illustrates another cooperation method of L1/L2 handover and L3 handover according to embodiments of the disclosure;

FIG. 17 illustrates another cooperation method of L1/L2 handover and L3 handover according to embodiments of the disclosure; and

FIG. 18 illustrates another cooperation method of L1/L2 handover and L3 handover according to embodiments of the disclosure.

FIG. 19 illustrates a schematic diagram of a node in a wireless communication system according to embodiments of the disclosure.

FIG. 20 illustrates a schematic diagram of a user equipment in a wireless communication system according to embodiments of the disclosure.

### BEST MODE FOR CARRYING OUT THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

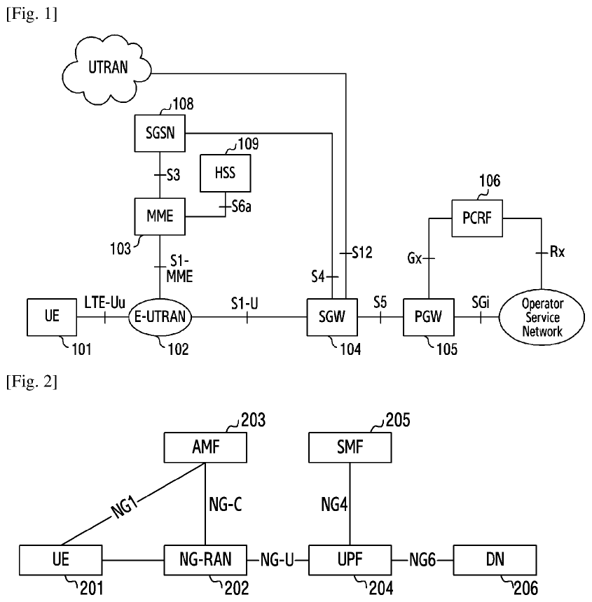

FIGS. 1 to 14 discussed below and various embodiments for describing the principles of the disclosure in this patent document are only for illustration and should not be interpreted as limiting the scope of the disclosure in any way. Those skilled in the art will understand that the principles of the disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

FIG. 2 is an exemplary system architecture 200 according to various embodiments of the disclosure. Other embodiments of the system architecture 200 can be used without departing from the scope of the disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

Exemplary embodiments of the disclosure are further described below with reference to the accompanying drawings.

The text and drawings are provided as examples only to help understand the disclosure. They should not be interpreted as limiting the scope of the disclosure in any way. Although certain embodiments and examples have been provided, based on the disclosure herein, it will be apparent to those skilled in the art that changes may be made to the illustrated embodiments and examples without departing from the scope of the disclosure.

A detailed description of steps irrelevant to the disclosure is omitted in the disclosure. In the following embodiments, description is performed taken a 5G system as an example, taken a CU as an example of a central unit of the access network, and taken a DU as an example of a distributed unit. The methods are also applicable to corresponding entities in other systems.

In the disclosure, a node may be a complete base station (e.g., gNB, or eNB, or en-gNB, or ng-eNB) or a base station including a central unit and a distributed unit. The gNB may be a single base station, or may be a master base station/Master Node (MN) or a secondary base station/Secondary Node (SN) in Dual Connectivity (DC). A group of cells serving a UE in the MN is called a Master Cell Group (MCG), and a group of cells serving the UE in the SN is called a Secondary Cell Group (SCG). A primary cell of the MCG is called a Primary Cell (PCell), and a primary cell of the SCG is called a Primary SCG Cell (PSCell). When the MCG or SCG adopts Carrier Aggregation (CA), other cells other than the PCell and the PSCell are called Secondary Cells (SCells).

The candidate cell may be a candidate cell of the PCell, a candidate cell of the PSCell or a candidate cell of the SCell. In addition, a node may also refer to a central unit (CU) or a distributed unit (DU).

In a structure where the Central Unit (CU)/Distributed Unit (DU) is separated, a source cell and a target cell can be located under the same gNB-DU or different gNB-DUs during handover.

In the disclosure, names of messages (or information, indications, commands, etc.) are just examples, and messages (or information, indications, commands, etc.) may be named by other names. Sequence number of messages do not represent the order for performing the messages, but only the names of the messages.

The disclosure may include the following example aspects.

### Example Aspect 1: Method for Reducing Handover Delay

Delay (or handover interruption) of Layer 3 handover (L3 handover) is the time from the time when the UE receives a handover command from a source cell to the time when the UE accesses a target cell to start service transmission. The handover delay may include the following parts:
the first part: processing delay for the UE to receive a Layer 3 handover command and parse the Layer 3 signaling to obtain configuration information of a target cell therein;
the second part: processing delay for the UE to perform configuration of a physical layer, a Media Access Control (MAC)/Radio Link Control (RLC)/Packet Data Convergence Protocol (PDCP) layer according to the configuration information of the target cell in the Layer 3 handover signaling; and
the third part: delay for the UE to perform downlink and uplink synchronization with the target cell.

The above handover delay is large and needs to be further reduced.

Next, a method for reducing handover delay will be described in combination with Example 1 and Example 2.

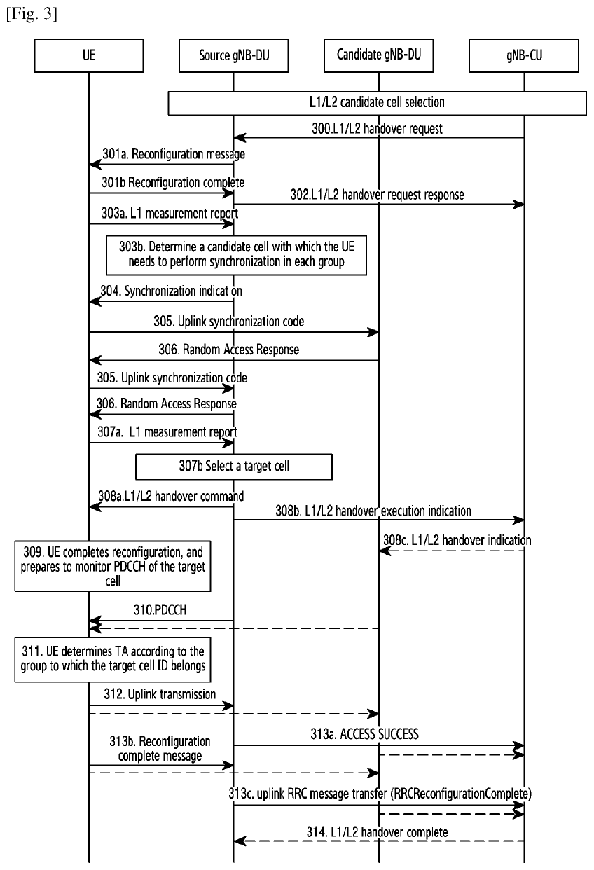

Example 1 gives a method for reducing handover delay. The UE establishes downlink and uplink synchronization with candidate target cells by performing an optimized random access process. The specific process is shown in FIG. 3.

The step of “L1/L2 candidate cell selection”: determination and information configuration of an L1/L2 handover candidate cell are completed among a gNB-CU and a gNB-DU where the candidate cell is located.
Step 300: the gNB-CU transmits an L1/L2 handover request message to a source gNB-DU, indicating that the gNB-DU can change a serving cell of the UE by an L1/L2 handover mechanism. The serving cell may be a Primary Cell (PCell), a Primary Secondary Cell (PSCell) or a Secondary Cell (Scell). The message contains at least one of the following information:
(1) a first L1/L2 handover indication, indicating that the gNB-DU can change the serving cell of the UE by an L1/L2 handover mechanism.
(2) first candidate cell information, which provides information of each candidate cell in the form of a list, and may include at least one of the following information:
candidate cell ID, which may be a Cell Global ID (CGI) or a Physical Cell ID (PCI).
Group ID to which a candidate cell belongs, indicating a group to which the candidate cell belongs, and candidate cells of the same group have the same downlink synchronization and uplink synchronization relationship with the UE.
candidate cell index (CandidateCellIndex), indicating an index of a candidate cell in a list of all the candidate cells. The range of values is (0~maxCandidateCells−1), where maxCandidateCells refers to the maximum number of candidate cells configured to the UE.
dedicated preamble, where each candidate cell allocates a dedicated preamble for random access to the UE, which can reduce the time for the UE to complete uplink synchronization with the candidate cell. If the network transmits the dedicated preamble to the UE when the L1/L2 handover is triggered, the gNB-DU includes the received dedicated preamble in synchronization indication information and transmits it to the UE. If the network directly transmits the dedicated preamble to the UE, the dedicated preamble is included in an RRC reconfiguration message transmitted to the UE.
(3) an RRC reconfiguration message transmitted to the UE, which is included in the L1/L2 handover request message in the form of an RRC-Container. The following is included therein:
timer T, used to determine whether the L1/L2 handover of the UE is successful during the performing process of the L1/L2 handover. After the UE receives an L1/L2 handover command and completes configuration of the target cell, it starts the timer T and starts to monitor PDCCHs in the target cell. If the timer T expires and the UE has not monitored a PDCCH transmitted to itself by the target cell yet, it is considered that the L1/L2 handover fails, and the UE will perform cell selection and select a suitable cell to access. By setting the timer T, it is ensured that the UE can select a suitable cell to access in time when the UE cannot access the target cell, thus reducing the impact on the service quality of the UE caused by the L1/L2 handover failure.
dedicated preamble, where each candidate cell allocates a dedicated preamble for random access to the UE.
measurement configuration information, containing at least one of the following information:
measurement configuration information for L1/L2 handover
configuration information for L3 measurement.
(4) measurement configuration information, containing measurement configuration information for L1/L2 handover.

The L1/L2 handover request message may be a UE context modification request message (UE CONTEXT MODIFICATION REQUEST), or other messages.
Step 301a: the source gNB-DU transmits a reconfiguration message (RRCReconfiguration) to the UE, which contains configuration information of candidate cells. The reconfiguration message is transmitted by the gNB-CU to the source gNB-DU in the form of an RRC-container, and transmitted by the source gNB-DU to the UE. The message may contain at least one of the following information:
(1) a second L1/L2 handover indication, indicating the UE that the network will use the L1/L2 handover mechanism to change the serving cell of the UE to ensure the service transmission quality;
(2) first candidate cell information, which provides information of each candidate cell in the form of a list, and includes at least one of the following information:
candidate cell ID, which may be a CGI or a PCI.
Group ID to which a candidate cell belongs, indicating a group to which the candidate cell belongs, and candidate cells of the same group have the same downlink synchronization and uplink synchronization relationship with the UE. The grouping of candidate cells may be completed by the gNB-CU, and the group information of candidate cells is transmitted to the gNB-DU through Step 300, and then forwarded to the UE by the gNB-DU; alternatively, the grouping of candidate cells may be completed by the gNB-DU and then the group information of candidate cells is transmitted to the UE.
candidate cell index (CandidateCellIndex), indicating an index of a candidate cell in a list of all the candidate cells. The range of values is (0~maxCandidateCells−1).
ID of the UE in the candidate cell, which may be a C-RNTI or other user identification information.
resource information, physical layer resource information, service configuration information, etc. configured by the candidate cell for the UE.
timer T, used to determine whether the L1/L2 handover of the UE is successful during the performing process of the L1/L2 handover. After the UE receives an L1/L2 handover command and completes configuration of the target cell, it starts the timer T and starts to monitor PDCCHs in the target cell. If the timer T expires and the UE has not monitored a PDCCH transmitted to itself by the target cell yet, it is considered that the L1/L2 handover fails, and the UE will perform cell selection and select a suitable cell to access. By setting the timer T, the impact on the service quality of the UE caused by the L1/L2 handover failure is reduced. The setting of timer T may be completed by the gNB-CU, transmitted to the gNB-DU through Step 300, and then forwarded to the UE by the gNB-DU, or it may be completed by the gNB-DU.
dedicated preamble, where each candidate cell allocates a dedicated preamble for random access to the UE.
Step 301b: the UE transmits a reconfiguration complete message (RRCReconfiguration Complete) to the source gNB-DU.
Step 302: the source gNB-DU transmits an L1/L2 handover request response message to the gNB-CU, indicating that the source gNB-DU accepts the L1/L2 handover request. The message may be a UE context modification response message (UE CONTEXT MODIFICATION RESPONSE), or other messages.
Step 303a: the UE transmits a Layer 1 measurement report to the source gNB-DU, and provides link quality of the candidate cells for L1/L2 handover to the source cell.
Step 303b: the source gNB-DU selects a cell list (e.g., a second list) of candidate cells with which downlink and uplink synchronization needs to be performed for the UE in different groups according to the measurement results obtained in Step 303a. For example, as mentioned above, the source gNB-DU selects one candidate cell with which downlink and uplink synchronization needs to be performed for the UE in each group.
Step 304: the source gNB-DU transmits synchronization indication information to the UE, and transmits the cell list information (for example, the second list) of the candidate cells with which the UE needs to perform downlink and uplink synchronization determined in Step 303b to the UE, and indicates the UE to perform synchronization with the candidate cells in the list. This information may be transmitted through a MAC control element (MAC CE) or physical layer signaling. The synchronization indication information may contain at least one of the following information:
second candidate cell information, which may be a candidate cell index or a candidate cell ID;
synchronization indication information, indicating whether the UE performs downlink and/or uplink synchronization with the candidate cell corresponding to the cell index or the candidate cell ID.
dedicated preamble, used for random access of the UE in the candidate cell, thereby reducing the time for the UE to complete uplink synchronization with the candidate cell.

If a MAC CE is adopted, a bit of the MAC CE corresponds to the candidate cell index, and if the value of the bit is 1, it means that the UE needs to perform downlink and/or uplink synchronization with the cell indicated by the candidate cell index. If the value of the bit is 0, it means that the UE does not need to perform downlink and/or uplink synchronization with the cell indicated by the candidate cell index.
Step 305: after the UE completes downlink synchronization with the candidate cell according to the cell information obtained in Step 304, the UE initiates a random access process and transmits an uplink preamble (also called uplink synchronization code) to the candidate cell. If the UE obtains the dedicated preamble of the candidate cell in Step 301a or Step 304, the UE will transmit the dedicated preamble to the candidate cell.
Step 306: the gNB-DU where the candidate cell is located transmits a Random Access Response (RAR) message to the UE, which contains an uplink preamble and a Timing Advance (TA) corresponding to the uplink preamble, and once the TA is obtained, the UE achieves uplink synchronization with the candidate cell. Through the grouping mechanism, once the downlink and uplink synchronization between the UE and one cell in a group is achieved, the downlink and uplink synchronization of all candidate cells in the group to which the cell belongs is achieved (for the sake of simplifying the description, it is called that the UE achieves downlink and uplink synchronization with a group, and obtains an uplink TA of the group), thus avoiding the requirement for the UE to perform downlink and uplink synchronization with all the candidate cells, and reducing energy consumption and processing requirements of the UE.

Therefore, through Steps 305 and 306, the UE will achieve downlink synchronization and uplink synchronization with a plurality of candidate cells. The plurality of candidate cells belong to different groups.

Since the candidate cell may be located in the source gNB-DU or other gNB-DUs in the gNB-CU, Steps 305 and 306 may be transmitted between the UE and the source gNB or other gNBs.
Steps 307a and 307b: the source gNB-DU (source cell) selects a target cell for L1/L2 handover for the UE according to the measurement result provided by the UE.
Step 308a: the source gNB/gNB-DU transmits an L1/L2 handover command to the UE, indicating the target cell ID of the UE handover. The handover command may be transmitted using physical layer signaling or MAC CE.
Step 308b: the source gNB-DU transmits an L1/L2 handover execution indication message to the gNB-CU, and indicates the gNB-CU that the gNB-DU changes the serving cell of the UE through an L1/L2 handover manner. The message contains at least one of the following information:
(1) information of the changed serving cell, indicating whether the L1/L2 handover is to change the UE's PCell (or PSCell) or SCell.
(2) cell ID. The target cell ID of the UE handover, which may be a CGI or other cell identification information. In case of an inter-gNB-DU cell handover, the gNB-CU needs to determine a target gNB-DU according to the cell ID, and performs Step 308c to inform the target cell to perform UE service data transmission.

The message may be a UE context modification required message (UE CONTEXT MODIFICATION REQUIRED), or other messages.
Step 308c: the gNB-CU transmits a third L1/L2 handover indication to the candidate gNB-DU, indicating that the UE will hand over to a cell belonging to the candidate gNB-DU. After receiving the indication, the candidate gNB-DU will prepare resources and transmit UE service data. The message may contain at least one of the following information:
cell ID. The target cell ID of the UE handover, which may be a CGI or other cell identification information.

The third L1/L2 handover indication message may be a UE context modification request message (UE CONTEXT MODIFICATION REQUEST), or other messages.
Step 309: the UE receives an L1/L2 handover command and obtains the target cell ID (for example, CGI, PCI, etc.) for handover. The UE performs configuration update according to the configuration information of the candidate cell obtained in Step 301a. At the same time, the UE determines the group to which the target cell belongs according to the group to which the candidate cell belongs obtained in Step 301a.

Since the UE has achieved downlink synchronization with the target cell or the candidate cells in the group in which the target cell is located in Step 305, the UE can directly monitor the physical downlink control channel (PDCCH) in the target cell.
Step 310: the gNB-DU to which the target cell belongs transmits downlink scheduling information or uplink grant information to the UE through the physical downlink control channel (PDCCH).
Step 311: the UE determines the uplink TA of the target cell. When the UE determines the group to which the target cell belongs according to the group to which the candidate cell belongs obtained in Step 301a, it determines the uplink TA value of the target cell by the TA of the group obtained in Steps 305 and 306. In Step 310, the UE receives downlink scheduling information to receive the downlink PDSCH service data, and the UE needs to perform ACK/NACK feedback (feedback information) on the received downlink data, or when the UE receives uplink grant information that it needs to transmit the uplink data (transmit uplink service data on the PUSCH), the UE may perform uplink transmission based on the determined uplink TA without obtaining a TA through an random access process, thus reducing handover delay of the UE.
Step 312: the UE performs uplink transmission according to the TA value determined in Step 311, which may be the transmission of feedback information (ACK/NACK) or uplink data (PUSCH). When the target cell receives uplink transmission, feedback information or uplink data from the UE, it is considered that the UE has successfully accessed to the target cell.
Step 313a: the gNB-DU (target gNB-DU) to which the target cell belongs transmits to the gNB-CU an indication message about the UE's successful access (ACCESS SUCCESS), indicating that the UE has completed L1/L2 handover and successfully accessed to the target cell. The message contains at least one of the following information:
(1) cell ID, indicating the target cell ID that the UE successfully accesses to through the L1/L2 handover mechanism, and the cell ID may be a CGI (Cell Global ID).
Step 313b: the UE transmits a reconfiguration complete message (RRCReconfigurationComplete) to the gNB-DU (target gNB-DU) to which the target cell belongs, and informs the CU that the cell handover is completed.
Step 313c: the target gNB-DU transmits an uplink RRC message transfer (UL RRC MESSAGE TRANSFER) to the gNB-CU, which contains the RRCReconfigurationComplete message transmitted by the UE to the gNB-CU.
Step 314: the gNB-CU transmits a UE L1/L2 handover complete message to the gNB-DU (source gNB-DU) to which the source cell belongs. This step is optional if the target cell and the source cell belong to the same gNB-DU. The message contains at least one of the following information:
(1) cell ID, indicating the target cell ID that the UE successfully accesses to through the L1/L2 handover mechanism, and the cell ID may be a CGI (Cell Global ID).
(2) candidate cell indication, indicating whether the source cell is served as a candidate cell for a subsequent L1/L2 handover of the UE.

The handover complete message may be a UE context modification request message (UE CONTEXT MODIFICATION REQUEST), or other messages.

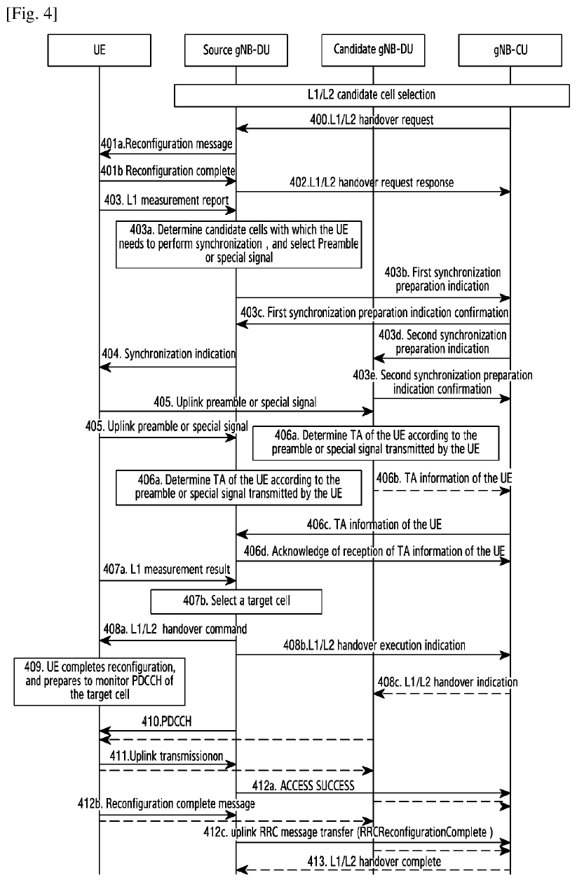

Example 2 gives another method for reducing handover delay. The UE transmits a signal to the candidate cell through an indication, and after the candidate cell determines the uplink timing, it transmits timing advance information to the source cell. Through this process, the UE and the candidate cell establish downlink and uplink synchronization in advance, thus reducing handover delay. Herein, a dedicated preamble or special signal used for the UE and the candidate cell to establish uplink synchronization in advance may be provided by the source cell, or may be provided by the candidate cell. The candidate cell may provide the dedicated preamble or special signal in an L1/L2 candidate cell selection stage (the gNB-CU may directly transmit the dedicated preamble or special signal to the UE through an RRC message, or it may be transmitted to the source cell by the gNB-CU and then transmitted to the UE; or it may be provided to the gNB-CU in the form of a container and then transmitted to the UE through an RRC message), or it may provide the same to the source cell when the source cell indicates the UE to perform synchronization with the candidate cell, and then transmitted by the source cell to the UE. The specific process is shown in FIG. 4.
Steps 400 and 402 are the same as Steps 300 and 302, and are not repeated here.
Step 401a: the source gNB-DU transmits a reconfiguration message (RRCReconfiguration) to the UE, which contains configuration information of the candidate cells. The reconfiguration message is transmitted by the gNB-CU to the source gNB-DU in the form of an RRC-container, and transmitted by the source gNB-DU to the UE. The message contains at least one of the following information:
(1) L1/L2 handover indication, indicating the UE that the network will use the L1/L2 handover mechanism to change the serving cell of the UE to ensure the service transmission quality;
(2) Candidate cell information, which provides each candidate cell information in the form of a list and includes at least one of the following information:
candidate cell ID, which may be a CGI or a PCI.
candidate cell index (CandidateCellIndex), indicating an index of a candidate cell in a list of all the candidate cells. The range of values is (0~maxCandidateCells−1).
ID of the UE in the candidate cell, which may be a C-RNTI or other user identification information.
resource information, physical layer resource information, service configuration information, etc. configured by the candidate cell for the UE.
timer T, used to determine whether the L1/L2 handover of the UE is successful during the performing process of the L1/L2 handover. After the UE receives an L1/L2 handover command and completes configuration of the target cell, it starts the timer T and starts to monitor PDCCHs in the target cell. If the timer T expires and the UE has not monitored a PDCCH transmitted to itself by the target cell yet, it is considered that the L1/L2 handover fails, and the UE will perform cell selection and select a suitable cell to access. By setting the timer T, the impact on the service quality of the UE caused by the L1/L2 handover failure is reduced.
dedicated preamble, where each candidate cell allocates a dedicated preamble for random access to the UE.
Step 403: the UE transmits measurement results to the source gNB-DU, and provides link quality of the candidate cells for L1/L2 handover to the source cell.
Step 403a: the source gNB-DU selects, for different cell groups, a list of candidate cells with which downlink and uplink synchronization needs to be performed for the UE according to the measurement results obtained in Step 403. Meanwhile, the gNB-DU determines a dedicated preamble or special signal (for example, it may be called synchronization signal herein) for the UE to perform uplink synchronization with the selected candidate cell. Through the received dedicated preamble transmitted by the UE, the candidate cell may identify the UE, and can determine that the uplink timing advance (TA) of the UE at the same time.
Step 403b: the source gNB-DU transmits a first synchronization preparation indication message to the gNB-CU, which contains a second synchronization preparation indication message transmitted by the source gNB-DU to the candidate gNB-DU. The message transmitted by the source gNB-DU to the gNB-CU may be a UE context modification required message (UE CONTEXT MODIFICATION REQUIRED) or other messages, which contains at least one of the following information:
(1) synchronization preparation indication container (Synchronization Preparation Container), which contains the second synchronization preparation indication message transmitted by the source gNB-DU to the candidate gNB-DU. The synchronization preparation indication message is used to indicate the candidate gNB-DU that the UE will transmit a dedicated preamble or a special signal in the candidate cell.
(2) candidate cell list information, which contains IDs of candidate cells with which the UE needs to perform downlink and uplink synchronization, which may be a CGI or PCI.
Step 403c: the gNB-CU transmits a first synchronization preparation indication confirmation message to the source gNB-DU, indicating that the message transmitted by the gNB-DU has been received. The confirmation message may be a UE context modification confirm message (UE CONTEXT MODIFICATION CONFIRM), or other messages. Step 403c may also be performed after Step 403e.
Step 403d: the gNB-CU transmits a second synchronization preparation indication message to the candidate gNB-DU, and transmits the synchronization indication message received from the source gNB-DU to the candidate gNB-DUs where each candidate cell is located obtained in Step 403a, which indicates that the UE will transmit a dedicated preamble or a special signal in the candidate cell. The message contains at least one of the following information:
(1) candidate cell information, which provides each candidate cell ID in the form of a list, and the candidate cell ID may be a CGI or PCI.
(2) dedicated preamble or special signal. The UE transmits the dedicated preamble or special signal to the candidate cell. By receiving the preamble or the special signal, the candidate cell may identify the UE, and determine the uplink timing advance (TA) value of the UE in the cell. By selecting the same dedicated preamble for the UE in each candidate cell, the occupation of preambles can be reduced, the utilization rate of preambles can be improved, and the influence on cell user access can be reduced.

The message may be a UE context modification request message (UE CONTEXT MODIFICATION REQUEST), or other messages.
Step 403e: the candidate gNB-DU transmits a second synchronization preparation indication confirmation message to the gNB-CU.

The message contains at least one of the following information:
(1) candidate cell information, which provides each candidate cell ID in the form of a list, and the candidate cell ID may be a CGI or PCI.
(2) dedicated preamble or special signal. If the second synchronization preparation indication message in Step 403d does not contain information of the dedicated preamble or special signal provided by the source cell, the dedicated preamble or special signal of each candidate cell is transmitted to the gNB-CU. By receiving the preamble or the special signal, the candidate cell may identify the UE, and determine the uplink timing advance (TA) value of the UE in the cell.

The message may be a UE context modification response message (UE CONTEXT MODIFICATION RESPONSE), or other messages.

If the candidate gNB-DU provides a dedicated preamble or a special signal, Step 403c will be performed after Step 403e. The first synchronization preparation indication confirmation message contains at least one of the following information:
(1) candidate cell information, which provides each candidate cell ID in the form of a list, and the candidate cell ID may be a CGI or PCI. The candidate cell information is corresponding to that transmitted by the source gNB-DU to the gNB-CU in Step 403b.
(2) dedicated preamble or special signal. By receiving the preamble or the special signal, the candidate cell may identify the UE, and determine the uplink timing advance (TA) value of the UE in the cell.
Step 404: the source gNB-DU transmits synchronization indication information to the UE, and transmits the cell list information and the dedicated preamble or special signal determined in Step 403a to the UE to indicate the UE to perform synchronization with the candidate cell. This information may be transmitted through a MAC Control Element (MAC CE) or physical layer signaling. This information contains at least one of the following information:
candidate cell information, which may be a candidate cell index (CandidateCellIndex), or a candidate cell ID, which may be a CGI or PCI;
synchronization indication information, indicating whether the UE performs downlink and/or uplink synchronization with the candidate cell corresponding to the cell index or the candidate cell ID.
dedicated preamble or special signal ID

If a MAC CE is adopted, a bit of the MAC CE corresponds to the candidate cell index, and if the value of the bit is 1, it means that the UE needs to perform downlink and/or uplink synchronization with the cell indicated by the candidate cell index. If the value of the bit is 0, it means that the UE does not need to perform downlink and/or uplink synchronization with the cell indicated by the candidate cell index.
Step 405: after completing downlink synchronization with the candidate cell according to the candidate cell information obtained in Step 404, the UE transmits an uplink preamble or special signal to the candidate cell.
Step 406a: the candidate cell (located in the source gNB-DU or the candidate gNB-DU) determines the TA value of the UE according to the preamble or special signal transmitted by the UE. The TA value of the UE in the candidate cell will be transmitted to the source gNB-DU. If the candidate cell is located in the candidate gNB-DU, Step 406b needs to be performed, and after the TA value of the UE in the candidate cell is transmitted to the gNB-CU, it is forwarded to the source gNB-DU by the gNB-CU.
Step 406b: the candidate gNB-DU transmits TA information of the UE to the gNB-CU. The TA information of the UE may contain at least one of the following information:
candidate cell information, which may be a candidate cell index (CandidateCellIndex), or a candidate cell ID, which may be a CGI or PCI;
timing advance (TA) value, the timing advance (TA) value of the UE determined in the candidate cell.

The TA information may be transmitted through a UE context modification required message (UE CONTEXT MODIFICATION REQUIRED), or other messages.
Step 406c: the gNB-CU forwards the TA information of the UE obtained in Step 406b to the source gNB-DU. The source gNB-DU obtains the TA value of the UE in each selected candidate cell. The TA value information of the UE may contain at least one of the following information:
candidate cell information, which may be a candidate cell index (CandidateCellIndex), or a candidate cell ID, which may be a CGI or PCI;
timing advance (TA) value, the timing advance (TA) value of the UE determined in the candidate cell.

The gNB-DU can determine TA values of the UE in other candidate cells according to the groups to which the selected candidate cells belong.

The TA value information may be transmitted through a UE context modification request message (UE CONTEXT MODIFICATION REQUEST), or other messages.
Step 406d: the source gNB-DU transmits a message to the gNB-CU, indicating that the TA information of the UE in the candidate cell has been received. The message may be a UE context modification response message (UE CONTEXT MODIFICATION RESPONSE), or other messages.
Steps 407a and 407b: the source gNB-DU (source cell) selects a target cell for L1/L2 handover for the UE according to the measurement result provided by the UE. Step 408a: the source gNB/gNB-DU transmits an L1/L2 handover command to the UE, indicating the UE to hand over the serving cell. The handover command may be transmitted using physical layer signaling or MAC CE. The handover command may contain at least one of the following information:
target cell ID, which may be a CGI or PCI.
TA value, indicating an uplink timing advance (TA) value of the UE in the target cell.
Step 408b: the source gNB-DU transmits an L1/L2 handover execution indication message to the gNB-CU, and indicates the gNB-CU that the source gNB-DU changes the serving cell of the UE through an L1/L2 handover manner. The message contains at least one of the following information:
(1) type information of the changed serving cell, indicating whether the L1/L2 handover is to change the UE's PCell (or PSCell) or SCell.
(2) cell ID. The target cell ID of the UE handover, which may be a CGI or other cell identification information. In case of an inter-gNB-DU cell handover, the gNB-CU needs to determine a target gNB-DU according to the cell ID, and performs Step 408c to inform the target cell to perform UE service data transmission The message may be a UE context modification required message (UE CONTEXT MODIFICATION REQUIRED), or other messages.
Step 408c: the gNB-CU transmits an L1/L2 handover indication to the candidate gNB-DU, indicating that the UE will be handed over to a cell belonging to the candidate gNB-DU. After receiving the indication, the candidate gNB-DU will prepare resources and transmit UE service data. The message contains at least one of the following information:
cell ID. The target cell ID of the UE handover, which may be a CGI or other cell identification information.
Step 409: the UE receives an L1/L2 handover command and obtains the target cell ID (for example, CGI, PCI, etc.) for handover. The UE performs configuration update according to the configuration information of the candidate cell obtained in Step 401.

Since the UE has achieved downlink synchronization with the target cell or the candidate cells in the group in which the target cell is located in Step 405, the UE can directly monitor the physical downlink control channel (PDCCH) in the target cell.
Step 410: the UE monitors the PDCCH channel. The gNB-DU to which the target cell belongs transmits downlink scheduling information or uplink grant information to the UE through the physical downlink control channel (PDCCH).
Step 411: the UE performs uplink transmission according to the TA value of the target cell obtained in Step 408a, where the uplink transmission may be the transmission of feedback information (ACK/NACK) or uplink data (PUSCH). When the target cell receives the uplink transmission from the UE, such as feedback information or uplink data, it is considered that the UE has successfully accessed to the target cell.
Step 412a: the gNB-DU (target gNB-DU) to which the target cell belongs transmits to the gNB-CU an indication message about the UE's successful access (ACCESS SUCCESS), indicating that the UE has successfully accessed to the target cell through L1/L2 handover. The message contains at least one of the following information:

cell ID, indicating the target cell ID that the UE successfully accesses to through the L1/L2 handover mechanism, and the cell ID may be a CGI (Cell Global ID).
Step 412b: the UE transmits a reconfiguration complete message (RRCReconfigurationComplete) to the gNB-DU (target gNB-DU) to which the target cell belongs, and informs the CU that the cell handover is completed.
Step 412c: the target gNB-DU transmits an uplink RRC message transfer (UL RRC MESSAGE TRANSFER) to the gNB-CU, which contains the RRCReconfigura-tionComplete message transmitted by the UE to the gNB-CU.
Step 413: the gNB-CU transmits an L1/L2 handover complete message of the UE to the gNB-DU to which the source cell belongs. This step is optional if the target cell and the source cell belong to the same gNB-DU. The message contains at least one of the following information:
(1) cell ID, indicating the target cell ID that the UE successfully accesses to through the L1/L2 handover mechanism, and the cell ID may be a CGI (Cell Global ID).
(2) candidate cell indication, indicating whether the source cell is served as a candidate cell for a subsequent L1/L2 handover of the UE.

The handover complete message may be a UE context modification request message (UE CONTEXT MODIFICATION REQUEST), or other messages.

The method for reducing handover delay according to embodiments of the disclosure is described above with reference to FIGS. 3 and 4. As mentioned above, in order to reduce the existing Layer 3 handover delay and reduce the impact on the service transmission of the UE in the handover process, the disclosure selects a plurality of candidate cells for the UE, and transmits configuration information of each candidate cell to the UE for storage and processing in advance, so that the UE will not process the configuration information of the target cell after receiving an handover command, thereby reducing the handover delay of the UE. By adopting a Layer 1/Layer 2 handover (L1/L2 handover, also called L1/L2 Mobility) manner, the handover command is transmitted to the UE through a control channel of the physical layer (such as the Physical Downlink Control Channel (PDCCH)) or a MAC CE of the MAC layer, thus reducing the processing delay of the UE in receiving and analyzing the Layer 3 signaling. In the L1/L2 handover, the MAC/RLC/PDCP layer does not need to be reconfigured through a MAC reset, RLC and PDCP reestablishment process, thus reducing the processing delay of the UE in the handover process.

In the disclosure, the UE completes downlink and uplink synchronization with the target cell in advance before performing L1/L2 handover, and after receiving the L1/L2 handover command, the UE will directly receive the downlink scheduling information or uplink grant information of the target cell to transmit service data, thereby further reducing handover delay of the UE and the service interruption during the handover process, and ensuring the service transmission quality of the UE.

In order to avoid the increasing requirement of processing capacity caused by downlink and uplink synchronization between the UE and multiple candidate cells, candidate cells for L1/L2 handover can be grouped through the network. If the UE completes downlink synchronization and uplink synchronization with any cell in a group, the UE will achieve downlink synchronization and uplink synchronization with all cells in the group. Based on this principle, the network groups the candidate cells. The network selects one cell for the UE in each group, indicates the UE to perform downlink and uplink synchronization with the selected cells and obtain timing advance (TA) values of uplink synchronization. Herein, there are two ways to obtain the timing advance, which are given in Example 1 and Example 2 above. Herein, in a network structure where CU/DU is separated, the grouping of candidate cells can be completed by the gNB-CU or gNB-DU.

### Example Aspect 2: Coordination Between L1/L2 Handover and L3 Handover

Both L1/L2 handover and L3 handover can be used for inter-cell handover within a gNB-CU (intra-gNB-CU handover), including inter-cell handover among gNB-DUs (inter-gNB-DU) within a gNB-CU (intra-gNB-CU) and inter-cell handover within a gNB-DU (intra-gNB-DU). L3 handover also can be used for inter-gNB-CU inter-cell handover. Therefore, L1/L2 handover and L3 handover will be configured at the same time.

If L3 handover is performed, configuration information of the candidate cells adopts a delta configuration manner, that is, configuration of the current serving cell of the UE is taken as a reference, and only configuration items of the candidate cells that are different from that of the current serving cell are provided. Moreover, if both L1/L2 handover and L3 handover are triggered, processing of the UE and the network would increase. Therefore, it is necessary to coordinate the L1/L2 handover and the L3 handover. If the gNB-CU doesn't know the change of UE's serving cell, the UE can't get configuration information of the target cell correctly, which leads to L3 handover failure. This patent proposes seven schemes to realize the cooperation between L1/L2 handover and L3 handover, and reduce the processing overhead of the UE and network while optimizing the handover performance.

Example 3 gives a cooperation method of L1/L2 handover and L3 handover.

When L1/L2 handover preparation is completed, that is, when the L1/L2 candidate cell selection and Steps 301a-302 of Example 1 are completed, if when the gNB-CU decides to trigger L3 handover, the source cell has already triggered the UE to perform L1/L2 handover to update the serving cell, the UE will no longer perform data transmission with the source cell. Therefore when the source gNB-DU receives an L3 handover message transmitted by the gNB-CU, if the source gNB-DU finds that configuration information of the candidate cells in the L3 handover message takes the configuration information of the source cell as a reference, the gNB-DU will transmit an L3 handover rejection message to the gNB-CU, thereby indicating the gNB-CU that the UE's serving cell is updated, and the configuration information for L3 handover needs to be updated. When the gNB-CU receives the L3 handover rejection message, it decides whether it is necessary to initiate an L3 handover request or update the configuration information of candidate cells for L3 handover to be transmitted to the UE.

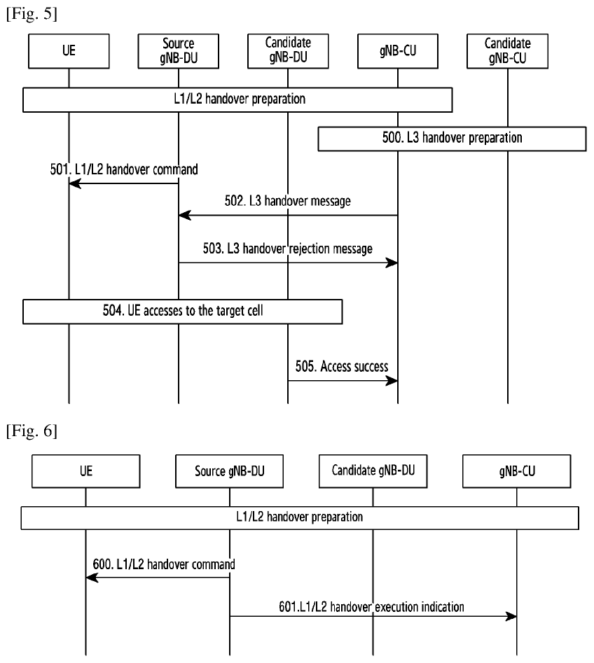

The specific process is shown in FIG. 5. Herein:
the step of “L1/L2 handover preparation” is the same as the L1/L2 candidate cell selection and Steps 301a-302 in Example 1, and will not be repeated here.
Step 500: the gNB-CU selects candidate cells for L3 handover for the UE and obtains configuration information of the candidate cells.
Step 501: the source gNB-DU transmits an L1/L2 handover command to the UE, indicating a target cell ID of the UE handover.
Step 502: the gNB-CU transmits a handover message to the source gNB-DU, indicating that the UE will be triggered to perform Layer 3 handover. The handover message contains a reconfiguration message transmitted to the UE, a configuration manner (delta configuration or full configuration) adopted by the target cell configuration, and a serving cell ID for reference.
Step 503: If the source gNB-DU has triggered the UE to perform L1/L2 handover, an L3 handover rejection message will be transmitted to the gNB-CU. The L3 handover rejection message contains a cause for rejection, which is the change of the serving cell, and the target cell of L1/L2 handover and configuration information of the target cell.
Step 505: when the handover of the UE is completed, the gNB-DU to which the target cell belongs transmits a message about the UE's successful access to the gNB-CU, indicating the gNB-CU that the UE has updated the serving cell through L1/L2 handover. The message at least contains: a target cell ID and a handover manner (L1/L2 handover or conditional handover).

Example 4 gives another cooperation method of L1/L2 handover and L3 handover.

When the source cell is to trigger the UE to perform L1/L2 handover, the gNB-DU to which the source cell belongs transmits L1/L2 handover execution information to the gNB-CU, indicating that the UE will update the serving cell. If the gNB-CU is ready to transmit a Layer 3 (L3) handover command, because of the serving cell update, the gNB-CU will not be able to determine the setting of configuration information of the candidate cells for L3 handover until the UE accesses the new target cell and obtains configuration information of the target cell.

The specific process is shown in FIG. 6.

the step of “L1/L2 handover preparation” is the same as the L1/L2 candidate cell selection and Steps 301a-302 in Example 1, and will not be repeated here.
Step 600: the source gNB-DU transmits an L1/L2 handover command to the UE, indicating a target cell ID of the UE handover.
Step 601: when the source cell triggers the UE to perform L1/L2 handover, the gNB-DU to which the source cell belongs will transmit an L1/L2 handover execution indication message to the gNB-CU, indicating that the UE will update the serving cell.

The gNB-CU knows in time that the serving cell is to be updated by UE, thus avoiding configuration information setting of the target cell for L3 handover by the gNB-CU using configuration of the source cell, and avoiding influencing the UE to correctly receive the Layer 3 handover command. The message contains at least one of the following information:
type information of the changed serving cell, indicating whether the L1/L2 handover is to change the UE's PCell (or PSCell) or SCell.

Example 5 gives another cooperation method of L1/L2 handover and L3 handover.

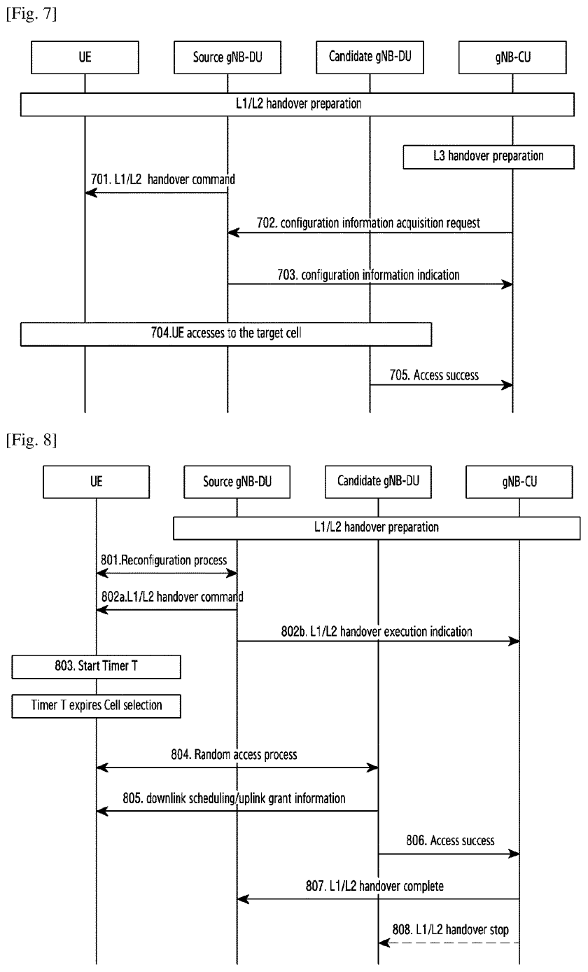

When the gNB-CU is ready to perform L3 handover, it transmits a configuration request message to the gNB-DU (source gNB-DU) where the UE's serving cell is located, requesting the current configuration information of the UE. If the UE is triggered to perform L1/L2 handover, the configuration information indication fed back by the source gNB-DU to the gNB-CU will indicate that the acquisition of the UE configuration information failed, and indicate that the UE is performing L1/L2 handover and updating the serving cell. If the gNB-CU does not get the current configuration information of the UE, it will stop triggering L3 handover, or it will configure resources for the candidate target cells for the UE in a full configuration manner. Therefore, it can avoid using wrong reference cell configuration information, which leads the UE not able to correctly interpret handover configuration information. The specific process is shown in FIG. 7. Herein:
the step of “L1/L2 handover preparation” is the same as the L1/L2 candidate cell selection and Steps 301a-302 in Example 1, and will not be repeated here.

L3 handover preparation: the gNB-CU selects candidate cells for L3 handover for the UE and obtains configuration information of the candidate cells.
Step 701: the source gNB-DU transmits an L1/L2 handover command to the UE, indicating a target cell ID of the UE handover.
Step 702: the gNB-CU transmits a configuration information acquisition request message to the gNB-DU where the UE's serving cell is located, requesting the current configuration information of the UE.
Step 703: the gNB-DU transmits a configuration information indication message to the gNB-CU. If the UE is triggered to perform L1/L2 handover, the gNB-DU feeds back to the gNB-CU that the acquisition of UE configuration information failed, and indicates that the reason for the failure of the acquisition of UE configuration information is that the UE is performing L1/L2 handover. Otherwise, configuration information of the UE will be provided to the gNB-CU.
Step 704: the UE accesses the target cell according to the L1/L2 handover command in step 701. The target cell can be located in the source gNB-DU or other gNB-DU.
Step 705: when the handover of the UE is completed, the gNB-DU to which the target cell belongs transmits a message about the UE's successful access to the gNB-CU, indicating the CU that the UE has updated the serving cell through L1/L2 handover. The message at least contains: a target cell ID and a handover manner (L1/L2 handover or conditional handover).

Herein, Examples 3 and 5 can be used in combination with Example 4 respectively.

Example 6 gives another cooperation method of L1/L2 handover and L3 handover.

In the stage of Layer 3 (L3) handover preparation, in case that the configuration information of the target cell adopts a delta configuration manner, when the target cell has been configured, the target gNB (also called a candidate gNB) has transmitted the configuration information of the target cell to the source gNB-CU/gNB, and if the L1/L2 handover causes a change of serving cell at this time, the UE will not be able to correctly obtain the configuration information of the target cell after receiving an L3 handover command. Therefore, the source gNB-CU/gNB may provide a set of cell configuration information as a reference (or referred to as reference cell configuration information, or referred to as cell configuration information for reference), as a reference for delta configuration of the target cell, and the UE can obtain full target cell configuration information based on the reference cell configuration information in combination with the delta configuration information of the target cell. Herein, configuration information of a cell from the candidate cells for L1/L2 handover or the current serving cell may be selected as the reference cell configuration information, or general reference cell configuration information (or called general cell configuration information or called first cell configuration information) or other cell configuration information may be used as the reference cell configuration information. The Layer 3 handover command transmitted by the source gNB-CU/gNB to the UE will contain the configuration information of the target cell and the referenced configuration indication information, which is used to indicate whether the general reference cell configuration information or other cell configuration information is adopted. The specific process is shown in FIG. 15. Herein, when L3 handover involves inter-gNB handover, the gNB-CU in the figure is a source gNB-CU with respect to the target gNB/gNB-CU.

The step “L1/L2 handover preparation”: the determination of candidate cells for L1/L2 handover and the configuration of cell information are completed between the gNB-CU and the gNB-DU where the candidate cell is located, which are the same as L1/L2 candidate cell selection and Steps 301a-302 in Example 1, and will not be described here. And the gNB-CU further needs to determine the reference cell configuration information, i.e., whether to use the general reference cell configuration information or select configuration information of a cell from the candidate cells for L1/L2 handover or the current serving cell as the reference cell configuration information.
Step 1501a: the source gNB-DU transmits a first reconfiguration message (RRCReconfiguration) to the UE, which contains configuration information related to L1/L2 handover and/or reference cell configuration information for L3 handover. The information contained in the first reconfiguration message contains at least one of the following information:
information contained in the reconfiguration message in Step 301a;
reference cell configuration information, which contains general reference cell configuration information.
Step 1501b: the UE transmits a reconfiguration complete message (RRCReconfiguration Complete) to the source gNB-DU.
Step 1501c: the UE transmits a Measurement Report to the gNB-CU.
Step 1502a: the gNB-CU transmits a handover request message (HANDOVER REQUEST) to the target gNB/gNB-CU, requesting to hand over the UE to a target cell and configuring resources for the UE. The handover request message contains at least one of the following information:
target cell ID, which is a cell CGI (Cell Global ID), or other IDs.
RRC context, which is transmitted to the target gNB/gNB-CU in the form of a handover preparation information message (HandoverPreparationInformation) in a Container manner by the gNB-CU, which includes at least one of the following information:
reference configuration cell ID (or referred to as a cell ID for reference, or referred to as a cell ID of the reference configuration), if the configuration information of the L1/L2 handover candidate cells or the current serving cell or other cells is used as the reference cell configuration information, and if the configuration information of the cell has been transmitted to the UE, it is necessary to provide the serving cell ID (servCellIndex), cell ID (CellIndex), and/or cell CGI (Cell Global ID). If the reference configuration cell ID is not included, the target cell considers the provided reference cell configuration information as general reference cell configuration information.
reference cell configuration information, which is used for the target cell to allocate resources for the UE and provide the configuration information (full configuration or delta configuration) of the target cell for the UE, which contains other information needed in the handover preparation information message except the reference configuration cell ID.
Step 1502b: the target gNB/gNB-CU transmits a handover request acknowledge message (HANDOVER REQUEST ACKNOWLEDGE) to the gNB-CU, indicating that the resource preparation is completed for the handover of the UE to the target cell. The target gNB/gNB-CU transmits the configured resources to the gNB-CU in the form of a container and in the format of a HandoverCommand message, and through a handover request confirmation message. The handover request confirmation message contains at least one of the following information:
full configuration usage indication, indicating whether the configuration information of the target message adopts a full configuration (fullconfig). If the full configuration usage indication is “true”, the configuration information provided by the target cell will be full configuration information, otherwise the configuration information provided by the target cell is delta configuration information based on the reference cell configuration information.
general reference cell configuration information indication (or the general cell configuration information indication or the first cell configuration information indication), which is used to indicate whether the reference cell configuration information is the general reference cell configuration information when the target cell configuration information adopts delta configuration. If the handover command message does not contain the general reference cell configuration information indication, the UE will obtain complete target cell configuration information based on the cell configuration information corresponding to the reference configuration cell ID. If the handover command message contains the general reference cell configuration information indication, the UE will obtain complete target cell configuration information based on the general reference cell configuration information obtained in Step 1501a. Or if the general reference cell configuration information indication is set to be “true”, the UE will obtain the complete target cell configuration based on the general reference cell configuration information obtained in Step 1501a. Otherwise, the UE will obtain complete target cell configuration information based on the cell configuration information corresponding to the reference configuration cell ID.
reference configuration cell ID. If the configuration information provided by the target cell is delta configuration information based on the reference configuration information, the reference configuration cell ID is used to indicate the reference cell ID of the delta configuration. The reference configuration cell ID may be a serving cell ID (servCellIndex), or a cell ID (CellIndex), and/or a cell CGI (Cell Global ID).
target cell configuration information. If full configuration is adopted, the target cell configuration information will contain full information of target cell configuration. If delta configuration is adopted, the target cell configuration information contains delta configuration information based on the reference cell configuration. The target cell configuration information is other information in the RRCReconfiguration message except the full configuration usage indication, general reference cell configuration information indication and the reference configuration cell ID.

The gNB-CU transmits the handover command message obtained from the target gNB to the UE through an RRC message by the source gNB-DU.
Step 1503: the gNB-CU transmits a UE context modification request message (UE CONTEXT MODIFICATION REQUEST) to the source gNB-DU, which contains the RRC message transmitted by the gNB-CU to the UE.
Step 1504: the source gNB-DU transmits a second RRC Reconfiguration message to the UE, which is used to indicate the UE to perform inter-gNB cell handover. The second reconfiguration message contains the information in the handover command message in Step 1502b.
Step 1505: the source gNB-DU transmits a UE context modification response message (UE CONTEXT MODIFICATION RESPONSE) to the gNB-CU, indicating that the RRC reconfiguration message has been transmitted to the UE.
Step 1506: the UE performs a random access process and accesses the target cell.
Step 1507: the UE transmits an RRC Reconfiguration Complete message to the target gNB/gNB-CU, indicating that the configuration of the target cell has been completed.
Step 1508: after the UE accesses the target cell, the target gNB/gNB-CU indicates the gNB-CU to release the UE context. The gNB-CU will indicate the source gNB-DU and the candidate gNB-DU to release the UE context.

Example 7 gives another cooperation method of L1/L2 handover and L3 handover.

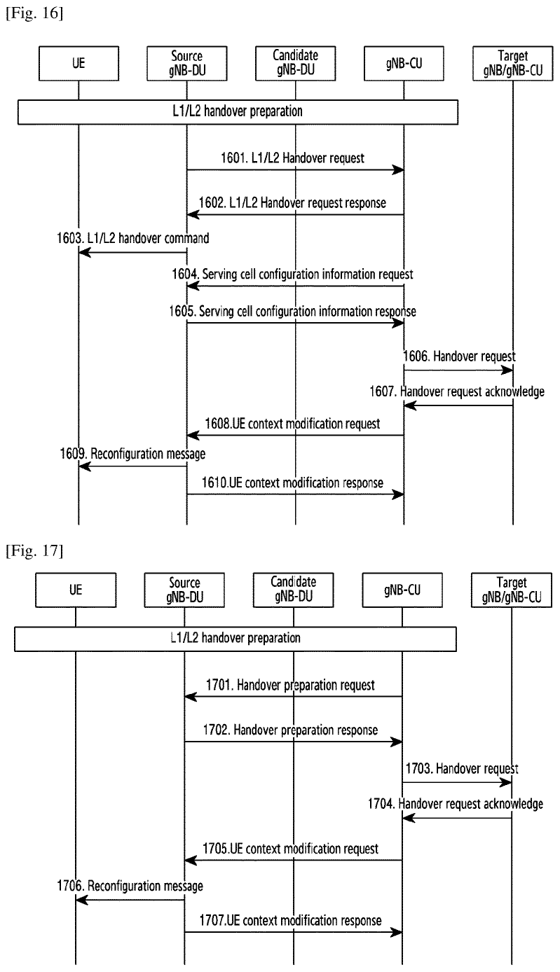

When the gNB-CU receives an L1/L2 handover request from the gNB-DU, if the gNB-CU (or RRC layer) is ready to trigger L3 handover according to an L3 measurement result reported by UE, the gNB-CU can decide whether to reject the L1/L2 handover request and adopt L3 handover to change the serving cell of the UE according to the quality of the target cell for L1/L2 handover and the target cell for L3 handover or other factors. When the gNB-CU receives the L1/L2 handover request from the gNB-DU, if the gNB-CU (or RRC layer) is not ready to trigger L3 handover, it will agree to the gNB-DU's L1/L2 handover request, that is, agree to change the serving cell of the UE by an L1/L2 handover manner. The specific process is shown in FIG. 16. Herein, when L3 handover involves inter-gNB handover, the gNB-CU in the figure is a source gNB-CU with respect to the target gNB/gNB-CU.

The stage of L1/L2 handover preparation includes L1/L2 candidate cell selection and Steps 301a-302 in Example 1, and Steps 1501a and 1501b in Example 6 (FIG. 15), which are not repeated here.
Step 1601: the source gNB-DU transmits an L1/L2 handover request message to the gNB-CU, requesting to perform L1/L2 handover to change the serving cell of the UE. The L1/L2 handover request message may be a UE context modification required message (UE CONTEXT MODIFICATION REQUIRED), or other messages.
Step 1602: the gNB-CU transmits an L1/L2 handover request response message to the source gNB-DU, indicating whether to agree to change the serving cell of the UE by L1/L2 handover. If the gNB-CU is not ready to trigger L3 handover at this time, or is ready to trigger L3 handover but decides to change the serving cell of the UE to the target cell of L1/L2 handover according to the quality of the target cell of L1/L2 handover and the target cell of L3 handover or other factors, it agrees with the L1/L2 handover request of the source gNB-DU, and will perform Step 1603 (other subsequent steps in FIG. 16 are not required), and the gNB-CU will stop triggering L3 handover (if it has preparation to trigger L3 handover before) and/or release related measurement results. Otherwise, if the gNB-CU (or RRC layer) decides to perform L3 handover or considers stopping L1/L2 handover, Steps 1604-1610 will be performed to prepare and perform L3 handover. The L1/L2 handover request response message may contain at least one of the following information:
L1/L2 handover indication, which is used to indicate whether to agree to perform L1/L2 handover.
Rejection cause. If L1/L2 handover is rejected, the rejection cause will be provided. For example, prepare to perform L3 handover.

When the feedback received by the source gNB-DU is that the L1/L2 handover is not agreed to be performed, the source gNB-DU will stop triggering L1/L2 handover.

The L1/L2 handover request response message may be a UE context modification confirm message (UE CONTEXT MODIFICATION CONFIRM), or other messages.
Step 1603: the source gNB-DU transmits an L1/L2 handover command to the UE, indicating the UE to switch to the target cell. The L1/L2 handover command may be transmitted using physical layer signaling or MAC CE.
Step 1604: the gNB-CU transmits a serving cell configuration information request message to the source gNB-DU, and requests the resource configuration information of the UE in the current serving cell from the source gNB-DU. The serving cell configuration information request message may be a UE context modification request message (UE CONTEXT MODIFICATION REQUEST), or other messages.
Step 1605: the source gNB-DU transmits a serving cell configuration information response message to the gNB-CU, and provides the gNB-CU with the resource configuration information of the UE in the current serving cell. The serving cell configuration information request message may be a UE context modification response message (UE CONTEXT MODIFICATION RESPONSE), or other messages.
Step 1606: the gNB-CU transmits a HANDOVER REQUEST to the target gNB/ gNB-CU, requesting to allocate resources for the UE to access the target cell. The handover request message contains at least one of the following information:
target cell ID, which is a cell CGI (Cell Global ID), or other IDs.
RRC context, which is transmitted to the target gNB/gNB-CU in the form of a handover preparation information message (HandoverPreparationInformation) in a Container manner by the gNB-CU, providing the current serving cell configuration information obtained in Step 1605.
Step 1607: the target gNB/gNB-CU transmits a handover request acknowledge message (HANDOVER REQUEST ACKNOWLEDGE) to the gNB-CU, indicating that the resource preparation is completed for the handover of the UE to the target cell. The target gNB/gNB-CU transmits the configured resources to the gNB-CU in the form of a container and in the format of a HandoverCommand message, and through a handover request confirmation message.
Steps 1608-1610: the gNB-CU transmits the handover command received in Step 1607 to the UE through the source gNB-DU in the form of an RRC message, indicating the UE to perform L3 handover. Herein the reconfiguration message in Step 1609 is an RRCReconfiguration message, or other messages; the messages in Step 1608 and Step 1609 are a UE context modification request message (UE CONTEXT MODIFICATION REQUEST) and a UE context modification response message (UE CONTEXT MODIFICATION RESPONSE), respectively, or other messages.

Example 8 gives another cooperation method of L1/L2 handover and L3 handover.

When the gNB-CU (or RRC layer) is ready to trigger L3 handover according to the L3 measurement result reported by the UE, it transmits an indication to the gNB-DU, and the gNB-CU will perform L3 handover to change the serving cell of the UE. When the gNB-DU receives the indication, it will suspend triggering L1/L2 handover. The gNB-CU transmits an RRC message to UE after obtaining the target cell configuration information, indicating the UE to perform L3 handover. The specific flow is shown in FIG. 17, where when the L3 handover involves inter-gNB handover, the gNB-CU in the figure is a source gNB-CU with respect to the target gNB/gNB-CU.

The stage of L1/L2 handover preparation includes L1/L2 candidate cell selection and Steps 301a-302 in Example 1, and Steps 1501a and 1501b in Example 6 (FIG. 15), which are not repeated here.
Step 1701: the gNB-CU transmits a handover preparation request message to the source gNB-DU, and transmits an indication to the source gNB-DU that the gNB-CU will perform L3 handover to change the serving cell of the UE, and indicates the source gNB-DU to provide the resource configuration information of the UE in the current serving cell. When the source gNB-DU receives the message, it will suspend triggering L1/L2 handover and provide the resource configuration information of the UE in the current serving cell. The handover preparation request message may be a UE context modification request message (UE CONTEXT MODIFICATION REQUEST), other messages.
Step 1702: the source gNB-DU transmits a handover preparation response message to the gNB-CU, and provides the gNB-CU with the resource configuration information of the UE in the current serving cell. The handover preparation response message may be a UE context modification response message (UE CONTEXT MODIFICATION RESPONSE), or other messages.
Steps 1704-1704: the target gNB/gNB-CU completes resource allocation of the target cell for the UE, and forms an RRC message to be transmitted to the UE. The specific contents are the same as those in Steps 1606-1607, and will not be repeated here.
Steps 1705-1707 are the same as Steps 1608-1610, and will not be repeated here.

Example 9 gives another cooperation method of L1/L2 handover and L3 handover.

If the gNB-DU and gNB-CU (or RRC layer) trigger L1/L2 handover and L3 handover at the same time, the L1/L2 handover command and RRC reconfiguration message can be transmitted to the UE respectively, and it is decided by the UE which target cell to select for access. The specific process is shown in FIG. 18.

The stage of L1/L2 handover preparation includes L1/L2 candidate cell selection and Steps 301a-302 in Example 1, and Steps 1501a and 1501b in Example 6 (FIG. 15), which are not repeated here. Which are not repeated here.

The UE performs L1 measurement and L3 measurement according to the measurement configuration information in the stage of L1/L2 handover preparation, and transmits a first measurement report and a second measurement report to the gNB-CU and the source gNB-DU respectively according to measurement reporting requirements.

If the gNB-CU decides to trigger L3 handover, through Steps 1802a-1802b, the target gNB/gNB-CU completes resource allocation of the target cell for the UE, and forms an RRC message to be transmitted to the UE. The specific contents are the same as those in Steps 1502a-1502b, and will not be repeated here. And through Steps 1803 and 1804a, an RRC reconfiguration message from the gNB-CU is transmitted to the UE through the gNB-DU, indicating the UE to perform L3 handover for cell change. The details are the same as Steps 1503-1504.

If the gNB-DU decides to trigger L1/L2 handover, it transmits an L1/L2 handover command through Step 1804b to indicate the UE to perform cell change.

When the UE simultaneously receives the RRC reconfiguration message and the L1/L2 handover command through Steps 1804a and 1804b, it will decide which target cell to select for handover. If the cell in the L1/L2 handover command is selected, the L1/L2 handover execution process is performed, otherwise, the L3 handover execution process is performed.

### Example aspect 3: Method for Reducing UE Service Interruption When L1/L2 Handover Fails

In the process of L1/L2 handover, when the UE receives an L1/L2 handover command, it will directly monitor the PDCCH of the target cell to obtain downlink scheduling information or uplink grant information. If the UE can't monitor the PDCCH channel, it can't perform service transmission normally, which will affect the service transmission of the UE. In order to prevent the UE from not monitoring the PDCCH channel for a long time, which will affect the service transmission, this patent sets a timer T for L1/L2 handover. When the UE receives the L1/L2 handover command and completes the target cell configuration, it starts the timer T and starts to monitor the PDCCH in the target cell. If the timer T expires and the UE has not monitored the PDCCH transmitted to itself by the target cell, it is considered that the L1/L2 handover has failed. If the UE determines that the L1/L2 handover has failed, the UE will perform a cell selection process and restore the connection with the network as soon as possible, thus ensuring the service transmission.

Example 10 gives a method for recovering service connection when UE determines that L1/L2 handover has failed. The specific process is shown in FIG. 8. Since this embodiment focuses on how to determine the failure of the L1/L2 handover of the UE and how to ensure the UE to recovery the connection with the network, other steps, such as the step that the network selects the L1/L2 handover target cell according to the measurement result of the UE, which have been described in detail in Examples 1 and 2, are omitted here. Herein:
Step 801 is the same as Step 301, and Steps 802-802b are the same as Steps 308a-308b, and the details are not repeated here.

Herein, Step 801: the network configures a timer T for the UE during L1/L2 handover configuration.
Step 803: after receiving the L1/L2 handover command and completing the configuration of the target cell, the UE starts the timer T and starts monitoring the PDCCH in the target cell. If the timer T expires and the UE has not monitored the PDCCH transmitted to itself by the target cell, it is considered that the L1/L2 handover has failed, and the UE performs cell selection. Herein the information of the timer T is obtained by the UE through the reconfiguration message in Step 801.
If the target cell selected by the UE is a candidate cell for the L1/L2 handover configuration, the UE performs a random access process Step 804 in the selected target cell. In Message 3 (MSG3) of the random access process, the UE transmits a C-RNTI previously allocated to the UE by the target cell to the target cell, and the target cell identifies the UE through the received C-RNTI. If the communication context of the UE is still reserved in the target cell, after completing the random access process, the target cell considers that the UE has completed the L1/L2 handover, and will directly transmit downlink scheduling or uplink grant information to the UE, that is, performing Step 805. After completing the random access process, the UE will also monitor the PDCCH transmitted to itself in the target cell. If the PDCCH transmitted to the UE in Step 805 is received, the handover is considered successful.
If the cell selected by the UE is not a candidate cell for the L1/L2 handover configuration, the UE triggers an RRC reconstruction process to restore the connection with the network.
Step 804: the UE performs a random access process.
Step 805: the target cell transmits downlink scheduling/uplink grant information to the UE, indicating that the UE successfully accesses the target cell.
Step 806: the gNB-DU to which the target cell belongs transmits to the gNB-CU an indication message about the UE's successful access, indicating that the UE has completed L1/L2 handover and has successfully accessed to the target cell. The message contains at least one of the following information:
(1) cell ID, indicating the target cell ID that the UE successfully accesses to through the L1/L2 handover mechanism, and the cell ID may be a CGI (Cell Global ID).

The gNB-CU determines whether the target cell accessed by the UE and the target cell provided by the source cell in Step 802b are the same according to the received target cell ID. If the two target cells are different:
If the target cell selected by the source cell and the target cell selected by the UE are in the same gNB-DU, the gNB-CU only needs to perform Step 807 and transmit an L1/L2 handover complete message to the source gNB-DU. When the source cell can judge whether the target cell selected by the UE and the target cell selected by the source cell are the same according to the target cell ID in the L1/L2 handover complete message, if they are different, it indicates the selected target cell by the source cell to stop the L1/L2 handover process of the UE and stop the service scheduling for the UE.
If the target cell selected by the source cell and the target cell selected by the UE are in different gNB-DUs, the gNB-CU further needs to perform Step 808 while performing Step 807. Then the target cell selected by the source cell is indicated to stop the L1/L2 handover process of the UE and stop the service scheduling for the UE.
Step 807: the gNB-CU transmits an L1/L2 handover complete message of the UE to the gNB-DU to which the source cell belongs. The message contains at least one of the following information:
(1) cell ID, indicating the target cell ID that the UE successfully accesses to through the L1/L2 handover mechanism, and the cell ID may be a CGI (Cell Global ID).
(2) candidate cell indication, indicating whether the source cell is served as a candidate cell for a subsequent L1/L2 handover of the UE.

The L1/L2 handover complete message may be a UE context modification request message (UE CONTEXT MODIFICATION REQUEST), or other messages.
Step 808: the gNB-CU transmits an L1/L2 handover stop message to the gNB-DU to which the candidate cell belongs. If the target cell accessed by the UE is different from the target cell selected by the source cell, the gNB-CU transmits an L1/L2 handover stop message to the gNB-DU to which the target cell selected by the source cell belongs, indicating that the UE access to other cells and stop the service scheduling for the UE. The message contains at least one of the following information:
(1) cell ID, indicating the target cell ID that the UE successfully accesses to through the L1/L2 handover mechanism, and the cell ID may be a CGI (Cell Global ID).

The L1/L2 handover stop message may be a UE context modification request message (UE CONTEXT MODIFICATION REQUEST), or other messages.

Example 11 gives a method of L1/L2 target cell selection. The network does not need to determine a target cell for the UE. According to candidate cells and execution conditions of L1/L2 handover provided by the network, the UE selects a cell as the target cell to access that meets the execution conditions according to measurement results.

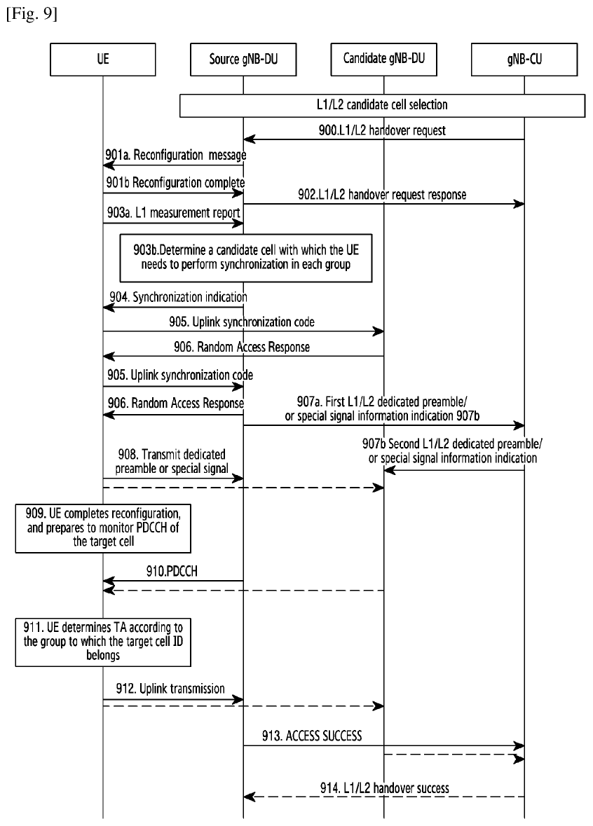

The specific process is shown in FIG. 9. Herein,

The step of “L1/L2 candidate cell selection”: determination and information configuration of an L1/L2 handover candidate cell are completed among a gNB-CU and a gNB-DU where the candidate cell is located.
Steps 902-906 and 909-914 are the same as Steps 302-306 and 309-314, and are not repeated here.
Step 900: the gNB-CU transmits an L1/L2 handover request message to the source gNB-DU, indicating that the gNB-DU can change the serving cell of the UE by L1/L2 handover mechanism, and the target cell can be selected by a conditional reconfiguration manner, that is, the target cell is selected by the UE. The serving cell may be a PCell, a PSCell or a Scell. In addition to the information in Step 300, the message further contains the following information:
(1) indication information about that the UE selects the target cell, indicating that the target cell for L1/L2 handover is selected and determined by the UE. It contains at least one of the following information:
L1/L2 handover execution conditions, herein when a measurement result of a candidate cell meet the execution conditions, it may be used as a target cell. If the message does not contain the L1/L2 handover execution conditions, the source gNB-DU (source cell) will determine the L1/L2 handover execution conditions of the candidate cells.
dedicated preamble or special signal, which is used for uplink synchronization when the UE accesses the target cell, or is used for the network to identify the UE. If the message does not contain the dedicated preamble or special signal, it is determined by the source gNB-DU.

The L1/L2 handover request message may be a UE context modification request message (UE CONTEXT MODIFICATION REQUEST), or other messages.
Step 901a: the source gNB-DU transmits a reconfiguration message (RRCReconfiguration) to the UE, which contains the configuration information of the candidate cells. The message may contain the information of Step 301a, and may further include the following information:
L1/L2 handover execution conditions, herein when a measurement result of a candidate cell meet the execution conditions, it may be used as a target cell.
dedicated preamble or special signal, which is used for transmission in the target cell when the UE accesses the target cell.

Since the target cell is selected based on the UE itself, after the UE completes the synchronization with the candidate cell selected by the network according to the network indication through Steps 904-906, the UE will determine whether there is a candidate cell that meets the L1/L2 handover execution conditions according to the measurement results.

When the UE monitors that there are candidate cells that meet the execution conditions of L1/L2 handover according to the measurement results, the UE will select one of them as the target cell, perform Step 908, and transmit a dedicated preamble or special signal to the target cell, which was obtained in Step 901a.
Step 908: when the target cell detects that the UE accesses the cell, it starts to schedule and transmit the UE service data, performs Step 910, and transmits the PDCCH to the UE for downlink scheduling or uplink grant of the UE service.

Since the network side does not need to select a target cell for the UE, if the dedicated preamble or special signal used in Step 908 is selected by the source gNB-DU, the network side transmits the preamble or special signal determined by the source gNB-DU to the candidate cell, in order for identifying the UE's access when the UE selects the candidate cell as the target cell, thereby performing Step 910. If the target cell and the source cell are in different gNB-DUs and need to be forwarded through the gNB-CU, Steps 907a and 907b need to be performed. Herein, the source gNB-DU may transmit a first L1/L2 dedicated preamble and/or special signal information indication to the gNB-CU using a UE context modification required message (UE CONTEXT MODIFICATION REQUIRED) or other messages. The source gNB-CU may transmit the received L1/L2 dedicated preamble and/or special signal information indication to the candidate gNB-DU through the second L1/L2 dedicated preamble and/or special signal information indication using a UE context modification request message (UE CONTEXT MODIFICATION REQUEST) or other messages.

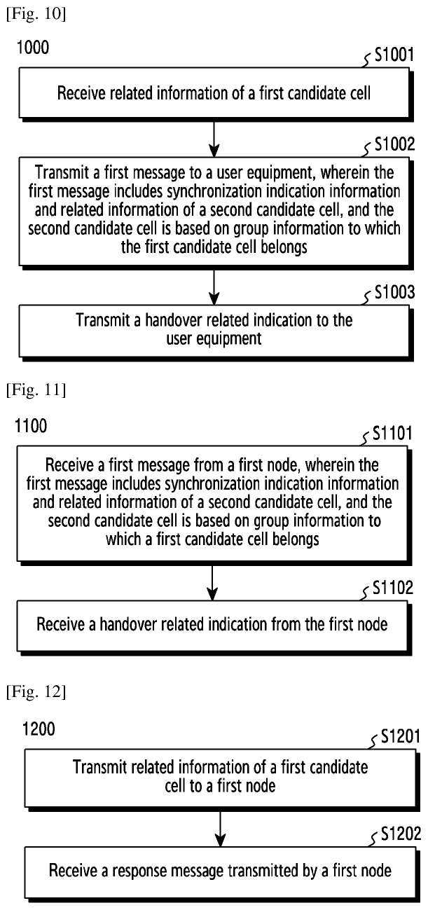

Next, FIG. 10 illustrates a flowchart of a method 1000 performed by a first node in a wireless communication system according to embodiments of the disclosure.

As shown in FIG. 10, a method 1000 performed by a first node in a wireless communication system according to embodiments of the disclosure may include the following steps. In step S1001, the first node may receive related information of a first candidate cell, for example, from a second node. In step S1002, the first node may transmit a first message to a user equipment, where the first message may include synchronization indication information and related information of a second candidate cell, and the second candidate cell may be based on group information to which the first candidate cell belongs. In some implementations, the group information to which the first candidate cell belongs may be determined by the first node itself or received from other nodes (e.g., the second node). In step S1003, the first node may transmit a handover related indication to the user equipment.

FIG. 11 illustrates a flowchart of a method 1100 performed by a user equipment in a wireless communication system according to embodiments of the disclosure.

As shown in FIG. 11, a method 1100 performed by a user equipment in a wireless communication system according to embodiments of the disclosure may include the following steps. In step S1101, the user equipment may receive a first message from a first node, where the first message may include synchronization indication information and related information of a second candidate cell, and the second candidate cell is based on group information to which the first candidate cell belongs. In step S1102, the user equipment may receive a handover related indication from the first node. In some implementations, the related information of the first candidate cell may be received by the first node (e.g., from a second node).

FIG. 12 illustrates a flowchart of a method 1200 performed by a second node in a wireless communication system according to embodiments of the disclosure.

As shown in FIG. 12, a method 1200 performed by a second node in a wireless communication system according to embodiments of the disclosure may include: in step S1201, the second node transmits related information of a first candidate cell to a first node. In step S1202, the second node receives a response message transmitted by the first node. In some implementations, the related information of the first candidate cell and group information to which the first candidate cell belongs may be used to determine a second candidate cell. In some implementations, the related information of the second candidate cell and synchronization indication information may be used to transmit to the user equipment for synchronization between the user equipment and the second candidate cell.

It should be understood that the methods 1000, 1100 and 1200 according to embodiments of the disclosure may also include one or more of the methods or steps as described above in connection with any examples or drawings, which are not repeated here.

Next, FIG. 13 illustrates a schematic diagram of a node 1300 in a wireless communication system according to embodiments of the disclosure.

As shown in FIG. 13, a node 1300 according to embodiments of the disclosure (which may be, for example, the first node, the second node or any other network node as described above) may include a transceiver 1310 and a processor 1320. The transceiver 1310 may be configured to transmit and receive signals. The processor 1320 may be coupled with the transceiver 1310 and may be configured to (e.g., control the transceiver 1310 to) perform any method performed by a node in a wireless communication system according to embodiments of the disclosure.

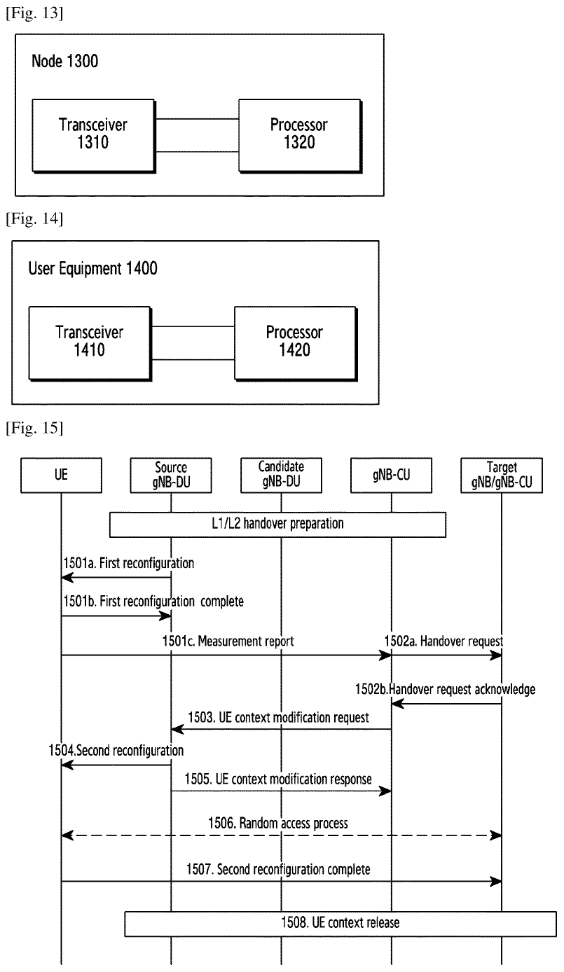

FIG. 14 illustrates a schematic diagram of a user equipment 1400 according to embodiments of the disclosure.

As shown in FIG. 14, a user equipment 1400 according to embodiments of the disclosure may include a transceiver 1410 and a processor 1420. The transceiver 1410 may be configured to transmit and receive signals. The processor 1420 may be coupled with the transceiver 1410 and may be configured to (e.g., control the transceiver 1410) perform any method performed by the user equipment according to embodiments of the disclosure. Herein, a processor may also be called a controller.

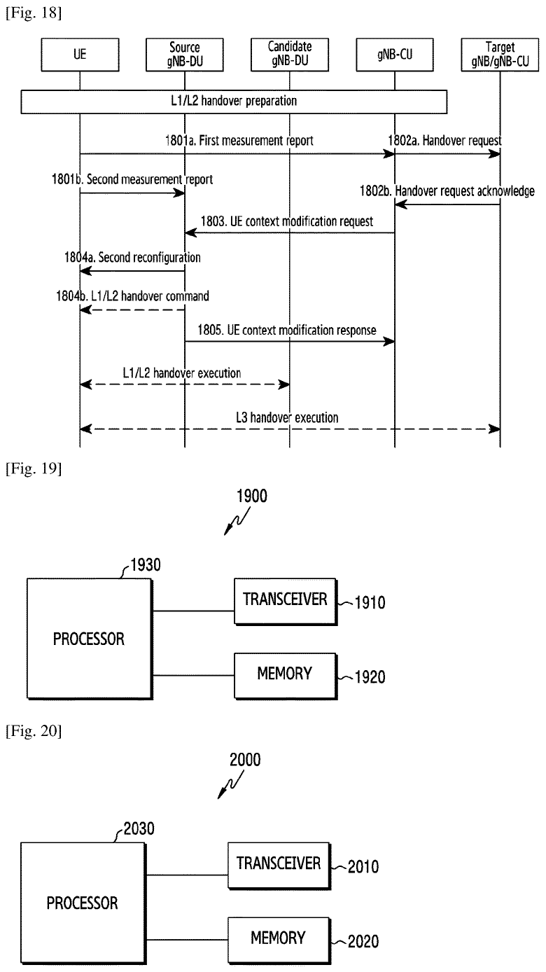

FIG. 19 illustrates a schematic diagram of a unit in a wireless communication system according to embodiments of the disclosure. the unit corresponds to gNB-DU, gNB-CU, or like.

As shown in FIG. 19, the unit according to an embodiment may include a transceiver 1910, a memory 1920, and a processor 1930. The transceiver 1910, the memory 1920, and the processor 1930 of the unit may operate according to a communication method of the unit described above. However, the components of the unit are not limited thereto. For example, the unit may include more or fewer components than those described above. In addition, the processor 1930, the transceiver 1910, and the memory 1920 may be implemented as a single chip. Also, the processor 1930 may include at least one processor. Furthermore, the unit of FIG. 19 corresponds to the unit of FIGS. 3 to 9 and FIGS. 15 to 18.

The transceiver 1910 collectively refers to an unit receiver and an unit transmitter, and may transmit/receive a signal to/from a terminal(UE) or a network entity. The signal transmitted or received to or from the terminal or a network entity may include control information and data. The transceiver 1910 may include a RF transmitter for up-converting and amplifying a frequency of a transmitted signal, and a RF receiver for amplifying low-noise and down-converting a frequency of a received signal. However, this is only an example of the transceiver 1910 and components of the transceiver 1910 are not limited to the RF transmitter and the RF receiver.

Also, the transceiver 1910 may receive and output, to the processor 1930, a signal through a wireless channel, and transmit a signal output from the processor 1930 through the wireless channel.

The memory 1920 may store a program and data required for operations of the unit. Also, the memory 1920 may store control information or data included in a signal obtained by the unit. The memory 1920 may be a storage medium, such as read-only memory (ROM), random access memory (RAM), a hard disk, a CD-ROM, and a DVD, or a combination of storage media.

The processor 1930 may control a series of processes such that the unit operates as described above. For example, the transceiver 1910 may receive a data signal including a control signal transmitted by the terminal, and the processor 1930 may determine a result of receiving the control signal and the data signal transmitted by the terminal.

FIG. 20 illustrates a schematic diagram of a user equipment (UE) in a wireless communication system according to embodiments of the disclosure.

As shown in FIG. 20, the UE according to an embodiment may include a transceiver 2010, a memory 2020, and a processor 2030. The transceiver 2010, the memory 2020, and the processor 2030 of the UE may operate according to a communication method of the UE described above. However, the components of the UE are not limited thereto. For example, the UE may include more or fewer components than those described above. In addition, the processor 2030, the transceiver 2010, and the memory 2020 may be implemented as a single chip. Also, the processor 2030 may include at least one processor. Furthermore, the UE of FIG. 20 corresponds to the UE of FIGS. 3 to 9 and FIGS. 15 to 18.

The transceiver 2010 collectively refers to a UE receiver and a UE transmitter, and may transmit/receive a signal to/from a base station or a network entity. The signal transmitted or received to or from the base station or a network entity may include control information and data. The transceiver 2010 may include a RF transmitter for up-converting and amplifying a frequency of a transmitted signal, and a RF receiver for amplifying low-noise and down-converting a frequency of a received signal. However, this is only an example of the transceiver 2010 and components of the transceiver 2010 are not limited to the RF transmitter and the RF receiver.

Also, the transceiver 2010 may receive and output, to the processor 2030, a signal through a wireless channel, and transmit a signal output from the processor 2030 through the wireless channel.

The memory 2020 may store a program and data required for operations of the UE. Also, the memory 2020 may store control information or data included in a signal obtained by the UE. The memory 2020 may be a storage medium, such as read-only memory (ROM), random access memory (RAM), a hard disk, a CD-ROM, and a DVD, or a combination of storage media.

The processor 2030 may control a series of processes such that the UE operates as described above. For example, the transceiver 2010 may receive a data signal including a control signal transmitted by the base station or the network entity, and the processor 2030 may determine a result of receiving the control signal and the data signal transmitted by the base station or the network entity.

In one embodiment of the disclosure, a method performed by a user equipment (UE) in a wireless communication system, comprising: receiving, from a source cell, an L1/L2 handover command including an identifier of a target cell and timing advance (TA) information related to the target cell, wherein the L1/L2 handover command is received using a MAC control element (MAC CE); monitoring a physical downlink control channel (PDCCH) for scheduling information from the target cell; transmitting, to the target cell, an uplink data.

In one embodiment of the disclosure, the method further comprising: transmitting, to the source cell, a measurement report for providing a link quality of the target cell.

In one embodiment of the disclosure, the method further comprising: receiving, from the source cell, a reconfiguration message including an identifier of the target cell and resource information.

In one embodiment of the disclosure, the method further comprising: transmitting, to the target cell, a reconfiguration complete message indicating a completion of an L1/L2 handover.

In one embodiment of the disclosure, a user equipment (UE), comprising: a transceiver; a processor coupled with the transceiver, the processor configured to: receive, from a source cell, an L1/L2 handover command including an identifier of a target cell and timing advance (TA) information related to the target cell, wherein the L1/L2 handover command is received using a MAC control element (MAC CE); monitoring a physical downlink control channel (PDCCH) for scheduling information from the target cell; transmitting, to the target cell, an uplink data.

In one embodiment of the disclosure, the processor of the UE further configured to: transmit, to the source cell, a measurement report for providing link quality of the target cell.

In one embodiment of the disclosure, the processor further configured to: receive, from the source cell, a reconfiguration message including an identifier of the target cell and resource information.

In one embodiment of the disclosure, the processor of the UE further configured to: transmit, to the target cell, a reconfiguration complete message indicating a completion of an L1/L2 handover.

In one embodiment of the disclosure, a method performed by a base station in a wireless communication system, comprising: transmitting, to a user equipment (UE), an L1/L2 handover command including an identifier of a target cell and timing advance (TA) information related to the target cell, wherein the L1/L2 handover command is transmitted using a MAC control element (MAC CE); transmitting, to the UE, a physical downlink control channel (PDCCH) including scheduling information; receiving, from the UE, an uplink data.

In one embodiment of the disclosure, the method further comprising: receiving, from the UE, a measurement report for providing a link quality of the target cell.

In one embodiment of the disclosure, the method further comprising: transmitting, to the UE, a reconfiguration message including an identifier of the target cell and resource information.

In one embodiment of the disclosure, the method further comprising: receiving, from the UE, a reconfiguration complete message indicating a completion of an L1/L2 handover.

In one embodiment of the disclosure, a base station (BS), comprising: a transceiver; a processor coupled with the transceiver, the processor configured to: transmit, to a user equipment (UE), an L1/L2 handover command including an identifier of a target cell and timing advance (TA) information related to the target cell, wherein the L1/L2 handover command is transmitted using a MAC control element (MAC CE); transmit, to the UE, a physical downlink control channel (PDCCH) including scheduling information; receive, from the UE, an uplink data.

In one embodiment of the disclosure, the processor of the BS further configured to: receiving, from the UE, a measurement report for providing a link quality of the target cell.

In one embodiment of the disclosure, the processor of the BS further configured to: transmit, to the UE, a reconfiguration message including an identifier of the target cell and resource information; receiving, from the UE, a reconfiguration complete message indicating a completion of an L1/L2 handover.

Various embodiments of the disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media can be distributed by computer systems connected via a network, and thus computer-readable codes can be stored and executed in a distributed manner. Furthermore, functional programs, codes and code segments for implementing various embodiments of the disclosure can be easily explained by those skilled in the art to which the embodiments of the disclosure are applied.

It will be understood that the embodiments of the disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a processor. Various embodiments may be implemented by a computer or a portable terminal including a controller and a memory, and the memory may be an example of a non-transitory computer-readable recording medium suitable for storing program(s) with instructions for implementing embodiments of the disclosure. The disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the disclosure suitably includes its equivalents.

What has been described above is only the specific implementation of the disclosure, but the scope of protection of the disclosure is not limited thereto. Anyone who is familiar with this technical field may make various changes or substitutions within the technical scope disclosed in the disclosure, and these changes or substitutions should be covered within the scope of protection of the disclosure. Therefore, the scope of protection of the disclosure should be based on the scope of protection of the claims.

1. A method performed by a user equipment (UE) in a wireless communication system, comprising:
receiving, from a source cell, an L1/L2 handover command including an identifier of a target cell and timing advance (TA) information related to the target cell, wherein the L1/L2 handover command is received using a MAC control element (MAC CE);
monitoring a physical downlink control channel (PDCCH) for scheduling information from the target cell; and
transmitting, to the target cell, an uplink data.

2. The method of claim 1, further comprising:
transmitting, to the source cell, a measurement report for providing a link quality of the target cell.

3. The method of claim 1, further comprising:
receiving, from the source cell, a reconfiguration message including an identifier of the target cell and resource information.

4. The method of claim 1, further comprising:
transmitting, to the target cell, a reconfiguration complete message indicating a completion of an L1/L2 handover.

5. A user equipment (UE), comprising:
a transceiver;
a processor coupled with the transceiver, the processor configured to:
receive, from a source cell, an L1/L2 handover command including an identifier of a target cell and timing advance (TA) information related to the target cell, wherein the L1/L2 handover command is received using a MAC control element (MAC CE);
monitoring a physical downlink control channel (PDCCH) for scheduling information from the target cell; and
transmitting, to the target cell, an uplink data.

6. The UE of claim 5, the processor further configured to: transmit, to the source cell, a measurement report for providing link quality of the target cell.

7. The UE of claim 5, the processor further configured to: receive, from the source cell, a reconfiguration message including an identifier of the target cell and resource information.

8. The UE of claim 5, the processor further configured to: transmit, to the target cell, a reconfiguration complete message indicating a completion of an L1/L2 handover.

9. A method performed by a base station in a wireless communication system, comprising:
transmitting, to a user equipment (UE), an L1/L2 handover command including an identifier of a target cell and timing advance (TA) information related to the target cell, wherein the L1/L2 handover command is transmitted using a MAC control element (MAC CE);
transmitting, to the UE, a physical downlink control channel (PDCCH) including scheduling information; and
receiving, from the UE, an uplink data.

10. The method of claim 9, further comprising:
receiving, from the UE, a measurement report for providing a link quality of the target cell.

11. The method of claim 9, further comprising:
transmitting, to the UE, a reconfiguration message including an identifier of the target cell and resource information.

12. The method of claim 9, further comprising:
receiving, from the UE, a reconfiguration complete message indicating a completion of an L1/L2 handover.

13. A base station (BS), comprising:
a transceiver;
a processor coupled with the transceiver, the processor configured to:
transmit, to a user equipment (UE), an L1/L2 handover command including an identifier of a target cell and timing advance (TA) information related to the target cell, wherein the L1/L2 handover command is transmitted using a MAC control element (MAC CE);
transmit, to the UE, a physical downlink control channel (PDCCH) including scheduling information; and
receive, from the UE, an uplink data.

14. The BS of claim 13, the processor further configured to:
receiving, from the UE, a measurement report for providing a link quality of the target cell.

15. The BS of claim 13, the processor further configured to:
transmit, to the UE, a reconfiguration message including an identifier of the target cell and resource information;
receiving, from the UE, a reconfiguration complete message indicating a completion of an L1/L2 handover.
